(19) United States
(12) Patent Application Publication
(10) Pub. No.: US 2005/0061935 A1
(43) Pub. Date: Mar. 24, 2005

(54) Clamp apparatus

(76) Inventor: Jon C. Leedholm, Austin, TX (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/935,407

(22) Filed: Sep. 7, 2004

Related U.S. Application Data
(60) Provisional application No. 60/500,890, filed on Sep. 5, 2003.

(51) Int. Cl. F16B 1/00

(52) U.S. Cl. 248/231.71; 248/228.6

(57) ABSTRACT

Disclosed herein are a clamp apparatus and a method of making the clamp apparatus. In an embodiment, the clamp apparatus comprises a C-shaped body that has a top portion and a bottom portion. The bottom portion of the C-shaped body is coupled to a fastening member such that the fastening member can tighten or loosen the clamp from a clamping surface, and at least one cord coupled to the C-shaped body. In another embodiment, the method for making a clamp apparatus comprises providing a C-shaped body such that the C-shaped body has a top portion and a bottom portion. The method further comprises coupling a fastening member to the bottom portion of the C-shaped body such that the fastening member can tighten or loosen the clamp from a clamping surface. In addition, the method comprises coupling at least one cord to the C-shaped body.

### CROSS-REFERENCE TO RELATED APPLICATION

This application claims priority to copending U.S. provisional application entitled, “A CLAMP APPARATUS,” having Ser. No. 60/500,890, filed on Sep. 5, 2003, which is entirely incorporated herein by reference.

### BACKGROUND OF THE INVENTION

Typically, people with infants spend a lot of time and money to keep their place clean, neat, orderly, and organized. For example, people with infants have difficulties preventing toys from getting dirty, particularly when the toys are dropped or thrown on the floor. In addition, it is difficult to prevent infants from dropping and throwing toys onto the floor and prevent toys from being damaged, particularly from high chairs, tabletops, strollers, and other locations. Infants typically like to drop or throw their toys causing frustration to the parents because they have to pick up the toys and often times they have to clean the toys, particularly pacifiers, a rattle, or a stuffed animal.

Therefore, it is desirable to have an apparatus that will prevent objects such as toys, from falling on the floor or ground. It is also desirable to have an apparatus that organizes the objects. It is also desirable to have an apparatus that eliminates the frustration of parents having to pick up objects off the floor.

### SUMMARY OF THE INVENTION

Disclosed herein are a clamp apparatus and a method of making the clamp apparatus. In an embodiment, the clamp apparatus comprises a C-shaped body that has a top portion and a bottom portion. The bottom portion of the C-shaped body is coupled to a fastening member such that the fastening member can tighten or loosen the clamp from a clamping surface, and at least one cord coupled to the C-shaped body.

In one embodiment, the method for making a clamp apparatus comprises providing a C-shaped body such that the C-shaped body has a top portion and a bottom portion. The method further comprises coupling a fastening member to the bottom portion of the C-shaped body such that the fastening member can tighten or loosen the clamp from a clamping surface. In addition, the method comprises coupling at least one cord to the C-shaped body.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a side view of an embodiment of a clamping apparatus.

FIG. 2 is a front view of an embodiment of a clamping apparatus.

FIG. 3 is a rear view of an embodiment of a clamping apparatus.

FIG. 4 is a bottom view of an embodiment of a clamping apparatus.

FIG. 5 is a bottom cross-section view of an embodiment of a clamping apparatus.

FIG. 6 is a flowchart illustrating an example of making a clamp apparatus.

### DETAILED DESCRIPTION OF THE PREFERRED EMBODIMENT

The present invention enables objects, such as toys, to be clean, neat, orderly, and organized. More particularly, the present invention is a clamping apparatus that prevents objects from falling on the ground/floor. The clamp apparatus further eliminates the frustration of having to pick up toys from the floor after the toys are dropped or thrown on the floor. The clamp apparatus includes a C-shaped body, a fastening member, and a cord coupled to the C-shaped body in which the cord is attached to the objects, such as toys, to prevent the objects from falling on the ground/floor. The fastening member is coupled to the body such that the fastening member can tighten or loosen the clamp from a clamping surface, such as high chairs, tabletops, strollers, and other locations.

Example apparatus are first discussed with reference to the figures. Although these apparatus are described in detail, they are provided for purposes of illustration only and various modifications are feasible. After the example apparatus have been described, an example flowchart is provided to explain the method of making the clamp apparatus.

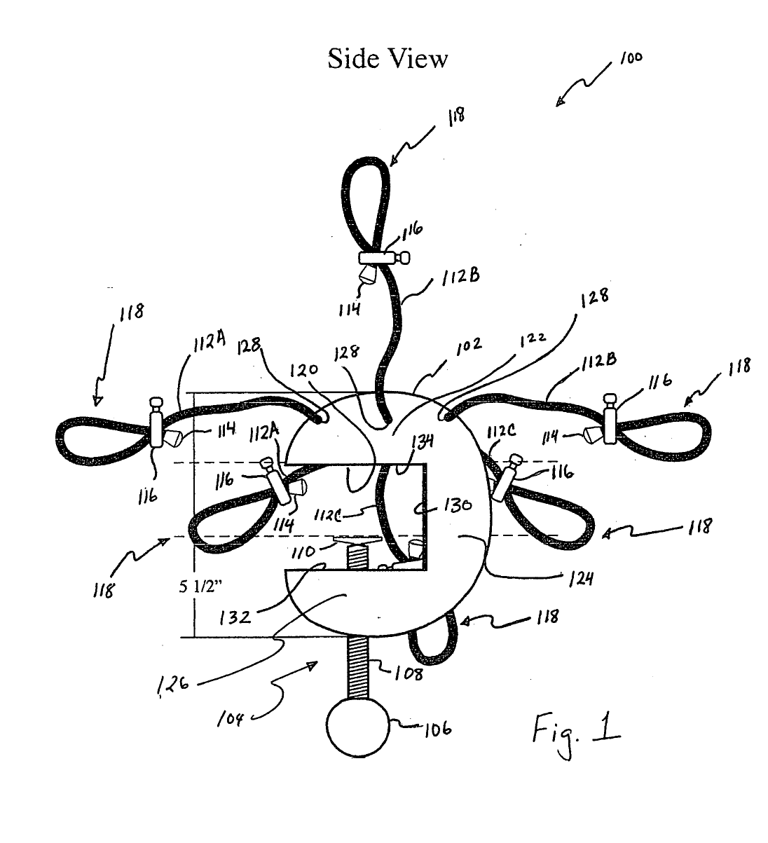

FIG. 1 is a side view of an embodiment of a clamp apparatus 100. Referring to FIG. 1, the clamp apparatus 100 includes a C-shaped body 102 having a top portion 122, a middle portion 124, and a bottom portion 126. A fastening member 104 is coupled to the bottom portion 126 of the C-shaped body 102 such that the fastening member 104 can tighten or loosen the clamp from a clamping surface. The C-shaped body 102 can be made into different shapes from animal heads to sport balls, such as ladybugs, soccer balls, footballs, etc. The fastening member 104 is used to tighten or loosen the clamp 100 on the clamping surface. The fastening member 104 includes a knob portion 106, a threaded portion 108, and a base portion 110. The knob portion 106 enables the fastening member 104 to turn in order to tighten or loosen the clamp on the clamping surface. The C-shaped body 102 further includes inside surfaces 134 of the top portion 122, 130 of the middle portion 124, and 132 of the bottom portion 126 of the body 102. The clamp apparatus 100 is placed onto the clamping surface, such as a high chair, tabletop, etc. via the inside surfaces 130, 132, 134. The base portion 110 contacts with the clamping surface as the fastening member 104 is tightening or loosening from the clamping surface.

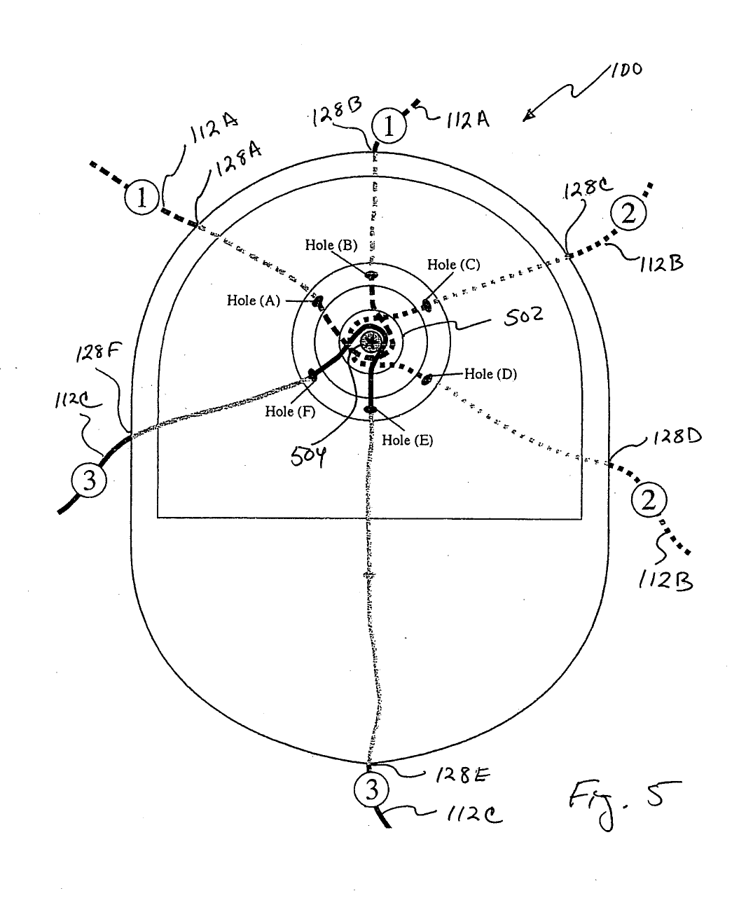

Referring to FIG. 1, the clamp apparatus 100 further includes at least one cord 112 that is coupled to the C-shaped body 102. The body 102 further includes at least one opening 128 to couple the cord 112 to the body 102. The opening 128 is preferably placed on the top portion 122 of the body 102; however, it can be placed anywhere on the body 102. The coupling of the cord 112 to the C-shaped body 102 is further described with reference to FIG. 5.

The cord 112 may include an end cap 114 and a sliding cord clamp 116. The sliding cord clamp 116 may couple the cord 112 at two points along the cord 112 to form a loop 118 (or attaching member), which is used to attach the objects, such as toys, to the clamp apparatus 100. In general, the objects can be of any nature that can be attached on the cord 112. The loop 118 can be used to hold toys, tools, kitchen utensils, school supplies, and/or office supplies. The sliding cord clamp 116 may include a button to release the toy from the loop 118 so that the sliding cord clamp 116 can adjust the loop 118 to hold or release the objects, such as toys. Although FIG. 1 shows a loop 118 to hold or release objects, other attaching members, such as Velcro, elastic, snaps, and buckles, that are coupled to the cord 112 may be used to hold or release objects.

The clamp apparatus 100 may further include a pad 120 that is attached to the inside surface 134 of the top portion 122 of the body 102. The pad 120 can be made of foam or rubber to prevent any damage to a clamping surface as the clamp apparatus 100 is being clamped to the clamping surface. The pad 120 may further be attached to the inside surface 130 of the middle portion 124 of the body 102.

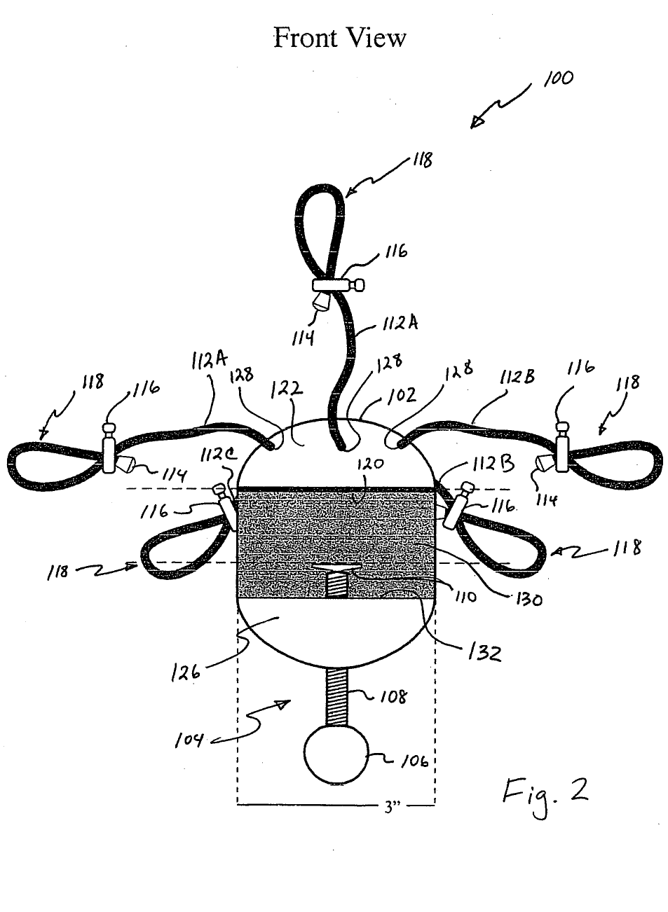

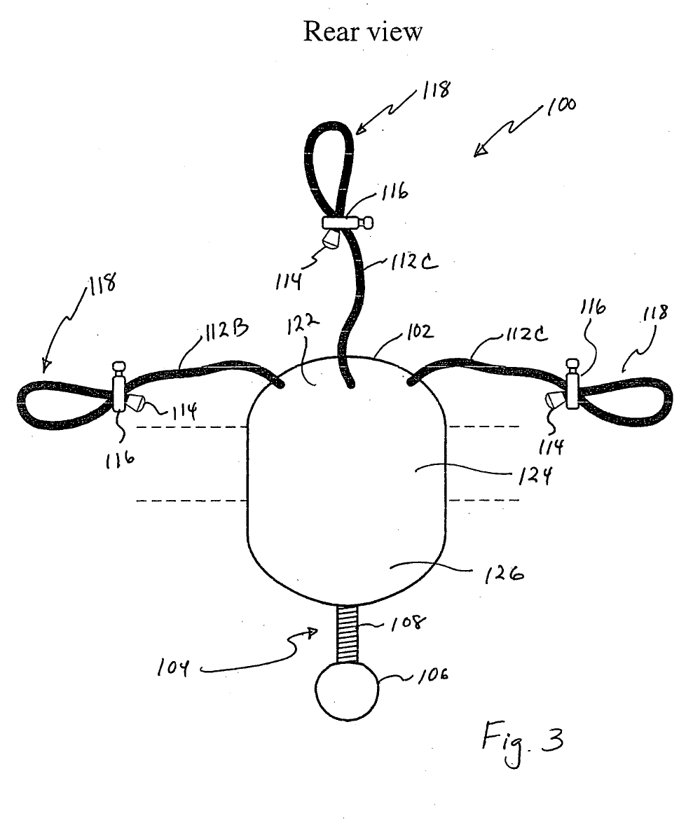

FIG. 2 is a front view of an embodiment of a clamp apparatus 100 and FIG. 3 is a rear view of an embodiment of a clamp apparatus 100. FIGS. 2 and 3 include all the components and features that were explained in FIG. 1.

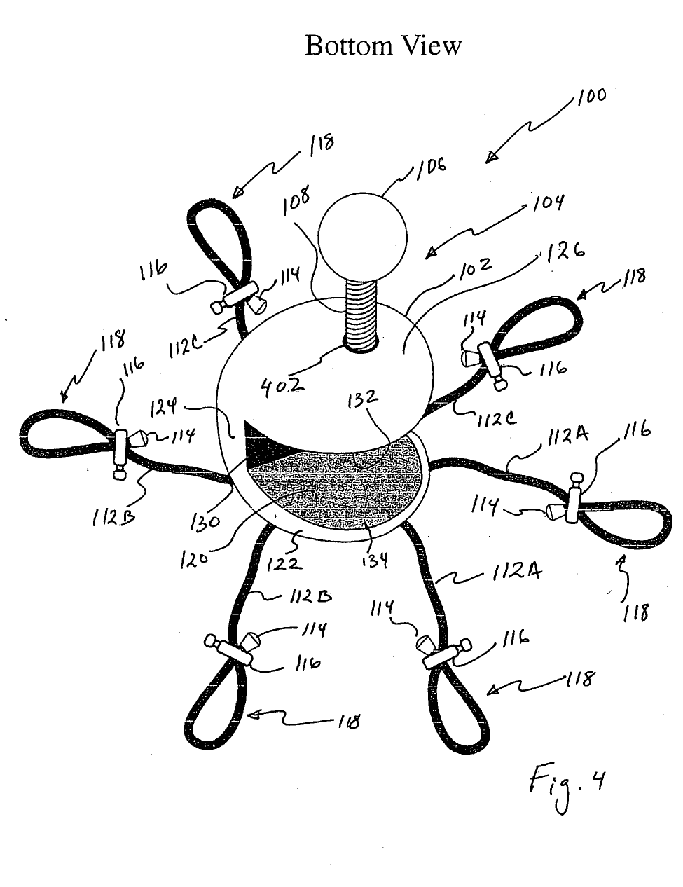

FIG. 4 is a bottom view of an embodiment of a clamp apparatus 100. FIG. 4 includes all the components and features that were explained in FIG. 1. FIG. 4 also shows a threaded opening 402 located on the bottom portion 126 of the body 102. The threaded opening 402 enables the fastening member 104 to couple to the body 102. The threaded opening 402 also allows the fastening member 104 to tighten or loosen the clamp 100 from a clamping surface.

FIG. 5 is a bottom cross-section view of an embodiment of a clamp apparatus 1100. Referring to FIG. 5, the clamp apparatus 100 includes a C-shaped body 102 and cords 112A-C. The body 102 further includes cord openings 128 such that the cord 112 can be coupled to the body 102. For example, cord 112A can be placed through the opening 128A to hole A of the body 102. The cord 112A is placed around a screw 504 and between a washer 502 and the C-shaped body 102. The cord 112A continues to be placed through hole B to opening 128B. Similarly, the cords 112B-C are coupled in a similar manner as explained with reference to cord 112A, but cords 112B-C are placed through openings 128C-F and holes C-F, respectively. The screw 506 is tightened such that the screw 506 secures the cords 112A-C on the body 102 via the washer 502 and prevents the cords 112A-C from being uncoupled from the body 102. Another option besides using the screw 504 and washer 502 is to tie a knot along the cords 112A-C between the loops 118 and the openings 128A-F. The knot prevents the cords 112A-C from being uncoupled from the body 102. Many variations and modifications may be made to couple the cord 112 to the body 102 without departing substantially from the spirit and principal of coupling the cord 112 to the body 102.

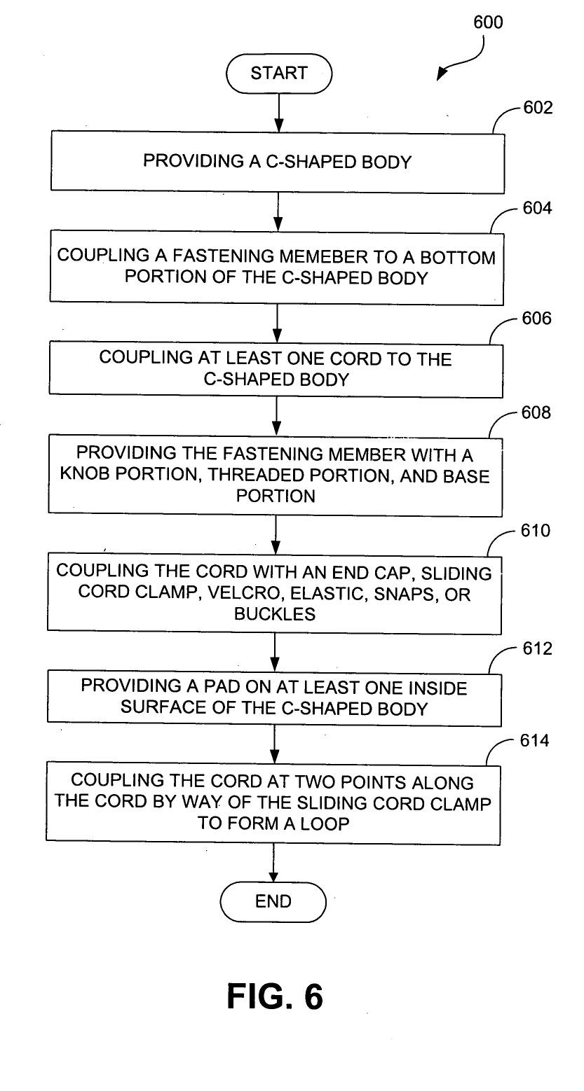

FIG. 6 is a flowchart illustrating an example of making a clamp apparatus 100. The method 600 for making the clamp apparatus 100 is comprised of providing a C-shaped body 102, as shown in block 602. The C-shaped body 102 may include a top portion 122, a middle portion 124, and a bottom portion 126 of the body 102. In block 604, the method 600 further comprising coupling a fastening member 104 to the bottom portion 126 of the C-shaped body 102. In block 606, the method 600 further comprises coupling at least one cord 112 to the C-shaped body 102. For example, the body 102 may include at least one opening 128 to attach the cord 112 to the body 102. The cord 112 can be attached to the body 102 as explained with reference to FIG. 5. For example, a screw 504 and a washer 502 may be provided wherein the screw 504 is coupled to the top portion 122 of the body 102 such that the screw 204 secures the cord 112 on the body 102 via the washer 502.

The method 600 may further comprise providing the fastener member 104 with a knob portion 106, threaded portion 108, and a base portion 110, as shown in block 608. In block 610, the method may further comprise coupling the cord 112 with an end cap 114 and a sliding cord clamp 116. The cord 112 may also be coupled to attaching members, such as Velcro, elastic, snaps, and buckles, to hold or release objects, such as toys. The method 600 may further comprise providing a pad 120 on at least one inside surface 130, 132, 134 of the body 102. Preferably, the body 102 is placed on the inside surface 134 of the top portion 120 of the body 102. In block 614, the method 600 may further comprise coupling the cord 112 at two points along the cord 112 by way of the sliding cord clamp 116 to form a loop 118 (or attaching members) that can hold or release objects, such as toys.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A clamp apparatus comprising:
a C-shaped body having a top portion and a bottom portion;
a fastening member coupled to the bottom portion of the C-shaped body such that the fastening member can tighten or loosen the clamp from a clamping surface; and
at least one cord coupled to the C-shaped body.

2. The apparatus as defined in claim 1, when the body includes at least one opening to couple the cord to the body.

3. The apparatus as defined in claim 1, wherein the top portion of the body includes at least one opening to couple the cord to the body.

4. The apparatus as defined in claim 1, wherein the cord includes one of an end cap and a sliding cord clamp.

5. The apparatus as defined in claim 4, wherein the sliding cord clamp couples the cord at two points along the cord to form a loop.

6. The apparatus as defined in claim 5, wherein the cord further includes an attaching member, wherein the attaching member is one of the loop, Velcro, elastic, snaps, and buckles that can be used to hold one of toys, tools, kitchen utensils, school supplies and office supplies.

7. The apparatus as defined in claim 1, further comprising a pad being provided on an inside surface of the top portion.

8. The apparatus as defined in claim 1, further comprising a screw and a washer, the screw being coupled to the top portion of the body, the screw being capable of securing the cord onto the body via the washer.

9. The apparatus as defined in claim 1, wherein the fastening member includes a knob portion, a threaded portion, and a base portion.

10. The apparatus as defined in claim 1, wherein the body may be conformed to different shapes.

11. The apparatus as defined in claim 5, wherein the sliding cord clamp can adjust the loop to hold or release an object.

12. A method for making a clamp apparatus; the method comprising:
providing a C-shaped body, the body having a top portion and a bottom portion;
coupling a fastening member to the bottom portion of the C-shaped body such that the fastening member can tighten or loosen the clamp from a clamping surface; and
coupling at least one cord to the C-shaped body.

13. The method as defined in claim 12, further comprising providing an opening in the body to couple the cord to the body.

14. The method as defined in claim 12, further comprising providing an opening on the top portion of the body to couple the cord to the body.

15. The method as defined in claim 12, further comprising coupling one of an end cap and a sliding cord clamp to the cord.

16. The method as defined in claim 15, further comprising coupling the cord at two points along the cord by way of the sliding cord clamp to form a loop.

17. The method as defined in claim 16, further comprising coupling the cord to an attaching member, wherein the attaching member is one of the loop, Velcro, elastic, snaps, and buckles, wherein the attaching member attaches an object to the cord.

18. The method as defined in claim 12, further comprising providing a pad on an inside surface of the top portion of the body.

19. The method as defined in claim 12, further comprising providing a screw and a washer, wherein the screw is coupled to the top portion of the body such that the screw secures the cord onto the body via the washer.

20. The method as defined in claim 12, further providing a knob portion, a threaded portion, and a base portion to the fastening member.
